(19) United States
(12) Patent Application Publication
(10) Pub. No.: US 2013/0038058 A1
(43) Pub. Date: Feb. 14, 2013

(54) METHOD AND APPARATUS FOR GENERATING ELECTRICITY

(71) Applicants: STEVEN DROSS, Orlando, FL (US); MICHAEL WIELAND, Orlando, FL (US)

(72) Inventors: STEVEN DROSS, Orlando, FL (US); MICHAEL WIELAND, Orlando, FL (US)

(21) Appl. No.: 13/205,898

(22) Filed: Aug. 9, 2011

(51) Int. Cl. F01D 17/24; F03B 13/00

(52) U.S. Cl. 290/43; 290/52

(57) ABSTRACT

An electrical generator apparatus for generating electrical energy is disclosed. The electrical generator utilizes liquid flow within a tubular member to provide mechanical force to rotate a rotor. The electrical generator includes a rotor comprising an impeller, wherein the rotor is configured to receive liquid flow within an electromagnetic induction armature from the tubular member, a stator configured to generate electrical energy within a plurality of coils utilizing a magnetic flux generated by the electromagnetic induction armature when rotated adjacent to the stator, and a bypass tubular member configured to selectively route liquid around the electrical generator to adjust voltage of generated electrical energy.

### TECHNICAL FIELD

This disclosure is related to electrical energy production, and more particularly to electrical production using liquid flow within a tubular enclosure.

### BACKGROUND

The statements in this section merely provide background information related to the present disclosure and may not constitute prior art.

Electric generators are well known in the art and used in many electric generation applications such as hydroelectric dams and windmills. Electric generators function, as one skilled in the art will readily recognize, to generate electrical current utilizing a mechanical force supplied from nature, such as provided by wind or water motion, or an extrinsic force such as provided by controlled chemical reactions or by humans such as by pedaling a stationary bicycle. For hydroelectric power generation within an enclosure, known mechanical means of generating electricity using an electric generator utilize mill wheels or wheel-based mechanical means to rotate magnets within the electric generator. Such methods can be inefficient and may require significant internal pressure changes or large enclosure limiting application to small or space-limited applications.

Water supply distribution networks are known to provide water to residential and business buildings. Smaller scale water distribution networks are utilized in consumer applications such as pool filtration systems. Water is generally delivered utilizing pressure that may be supplied in a number of ways such as by gravity, pump, or by compressed air. In most water distribution networks, water is delivered via circular pipes and tubes such as copper, iron-based, or plastic polymer-based pipes such as PVC tubing. At certain points in the water distribution network, there are opportunities to generate electricity utilizing water flow to turn magnets within the electric generator and generate electricity.

Therefore, it would be advantageous to generate electricity using an electric generator adapted for a piping enclosure and configured with a mechanical means contained within the piping enclosure utilizing liquid flow within a water supply network to rotate the mechanical means to generate electricity.

### SUMMARY

An electrical generator apparatus for generating electrical energy is disclosed. The electrical generator utilizes liquid flow within a tubular member to provide mechanical force to rotate a rotor. The electrical generator includes a rotor comprising an impeller, wherein the rotor is configured to receive liquid flow within the electromagnetic induction armature from the tubular member, a stator configured to generate electrical energy within a plurality of coils utilizing a magnetic flux generated by the electromagnetic induction armature when rotated adjacent to the stator, and a bypass tubular member configured to selectively route liquid around the electrical generator to adjust voltage of generated electrical energy.

Certain embodiments of the disclosure include an elongated impeller moveably connected to an electromagnetic induction armature and configured to magnetically rotate the electromagnetic induction armature when rotating within the electrical generator. In this way, certain gear elements of known electrical generators may be excluded from the electrical generator, minimizing physical space requirements and increasing efficiency.

Certain embodiments of the disclosure include a circular impeller directly connected to the electromagnetic induction armature and configured to directly move the electromagnetic induction armature when propelled by liquid flow within the electrical generator. Electrical generator embodiments including a circular impeller embodiment are preferably adapted specifically for certain applications including certain parameters of liquid flow within the tubular member for preferential operation.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows a partial sectional view of an electric generator system and corresponding electrical circuit, in accordance with the present disclosure;

FIG. 2 schematically shows a second embodiment of the electrical circuit, in accordance with the present disclosure;

FIG. 3 shows a liquid regulator used to control voltage in the electric generator system, in accordance with the present disclosure;

FIG. 4 is a cross-sectional view of the electric generator system, in accordance with the present disclosure;

FIG. 5 schematically shows coils of the electric generator system, in accordance with the present disclosure;

FIGS. 6A and 6B show exemplary embodiments of the impeller used in the electric generator system, in accordance with the present disclosure;

FIG. 7 shows a top view of the impeller shown in FIG. 6A, in accordance with the present disclosure;

FIG. 8A shows an alternative embodiment of the electric generator system using an alternative embodiment of the impeller that is shown in FIG. 8B, in accordance with the present disclosure;

FIG. 9 is a partial sectional side view of an input tube into the electric generator system and coupling means, in accordance with the present disclosure; and

FIG. 10 illustrates an exemplary user interface for controlling operation of the generator system, in accordance with the present disclosure.

### DETAILED DESCRIPTION

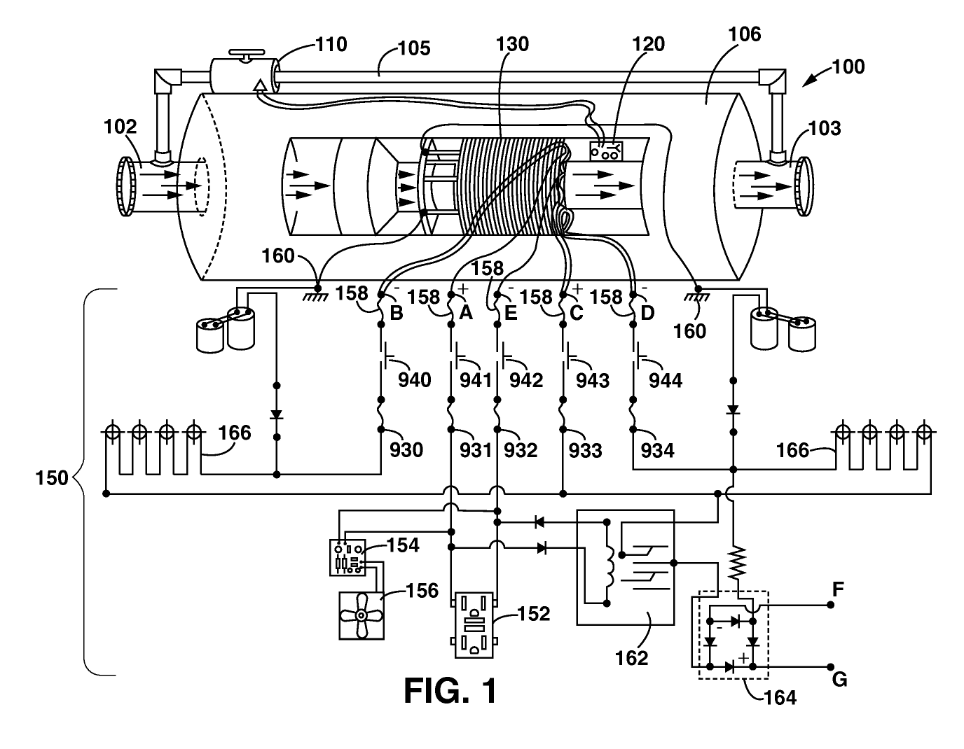

Referring now to the drawings, wherein the showings are for the purpose of illustrating certain exemplary embodiments only and not for the purpose of limiting the same, FIG. 1 schematically illustrates an electric generator system 100 including an exemplary electrical circuit 150 for utilizing the generator system 100. The electrical circuit 150 is preferably included within a housing 106 of the generator system 100. The generator system 100 includes an input tube 102 for receiving flow of a liquid-based substance, an output tube 103 for expelling flow, a liquid regulator 110, a voltage control unit 120, and an electrical generator 130.

The electrical generator 130 preferably includes stator(s), rotor(s), and/or additional components configured to generate electrical power using mechanical power. In one embodiment, the electrical generator 130 is additionally configured to selectively operate as an electric motor. The electric motor may serve, in particular applications, as a supplemental or backup pump to drive flow of the liquid. Additionally, the electrical generator 130 may be configured to selectively operate in forward and reverse directions when operating as either a motor or a generator. The electrical generator 130 is preferably connected to the electrical circuit 150 at nodes A, B, C, D, and E as shown in FIG. 1. The nodes A, B, C, D, and E are connected to coil strands of the electrical generator 130. As one skilled in the art will readily recognize, multiple arrangements of connections to the electrical generator 130 are possible based upon functions and components within the electrical circuit 150 and the disclosure herein is therefore not intended to be limited to the particular connection arrangement shown in the figures or discussed herein.

The electrical circuit 150 includes exemplary components that may be included to utilize electricity generated by the generator system 100. The electrical circuit 150 preferably includes electrical components configured to modulate electrical energy generated by the generator system 100 into an alternating current. In one embodiment, energy generated by the generator system 100 is modulated to produce electrical current at substantially 60 Hz and at substantially between 110 and 120 volts. Such a modulation would electrically power many standard consumer products when electrically connected to a conventional ground fault interrupter or ground fault circuit interrupter outlet, such as outlet 152 shown in FIG. 1.

The electrical circuit 150 may include a step-down circuit 154 configured to produce direct current at a predetermined voltage. A cooling fan 156 is preferably included in the electrical circuit 150 to reduce thermal energy within the generator system 100 and preferably powered by the step-down circuit 154. A plurality of fuses 158 may be included on the electrical circuit 150 to protect the generator system 100 from electrical surges or damaging thermal energy. The plurality of fuses 158 may include multiple fuse types configured for connecting components of the electrical circuit 150 with components of the electrical generator 130 when operating within predetermined parameters. In one embodiment, the plurality of fuses 158 are thermal fuses configured with a thermosensitive material to melt at a predetermined temperature thereby disconnecting the electrical generator 130 and components of the electrical circuit 150 when an undesirable operating temperature is achieved. Additional fuses 930, 931, 932, 933, and 934 may be included for additional protection.

The electrical circuit 150 preferably includes grounding components 160 to electrically ground the electrical generator 130 such as via a wire connected to a ground, wire connected to the housing 106, and/or similar means as well known in the art. As shown in FIG. 1, the electrical circuit 150 is configured to produce electrical current at points F and G, utilizing a relay 162 and a diode bridge 164. As an exemplary electrical load, lighting devices 166 are included in the electrical circuit 150. A plurality of switches 940, 941, 942, 943, and 944, or connectors in one embodiment, may be included for convenient operating state changes of electrical components and functions. Various additional electrical components are utilized in the electrical circuit 150 including capacitors, diodes, and resistors, as shown in FIG. 1. As one skilled in the art will recognize upon reading the teachings of this disclosure, quantity, operating parameters, and arrangement of the various electrical components may be changed for a particular embodiment of the generator system 100 and for particular applications of the generator system 100.

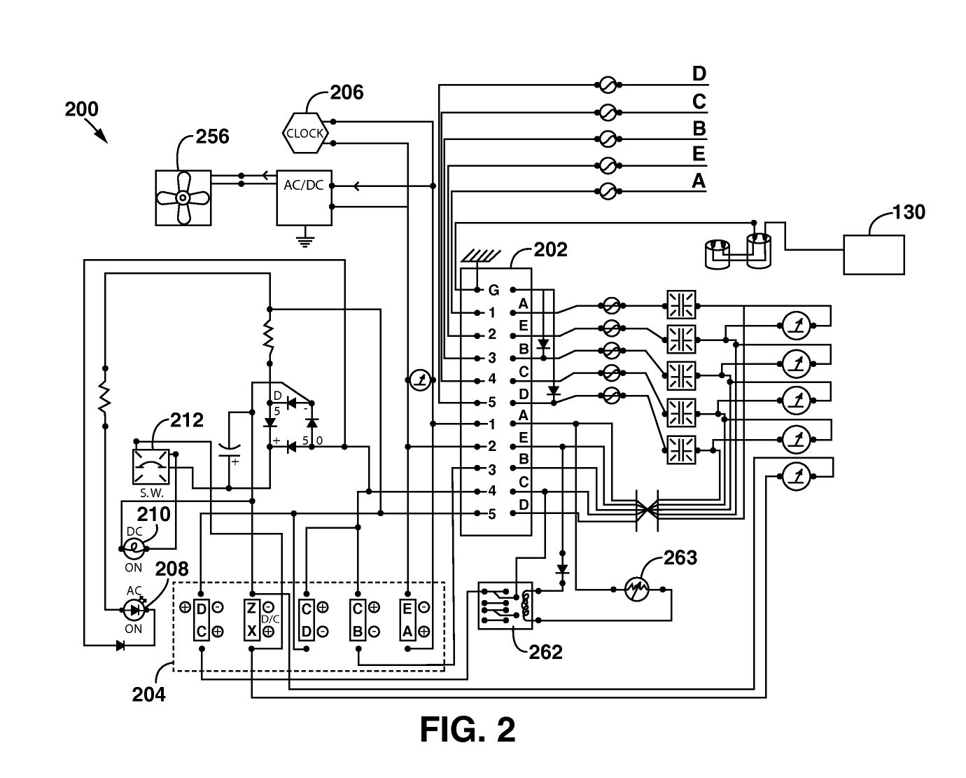

FIG. 2 schematically shows a second electrical circuit 200. The second electrical circuit 200 is an alternative embodiment of the electrical circuit 150 and may be used in more energy efficient applications of the generator system 100. The second electrical circuit 200 may be connected to the coils within the electrical generator 130 at nodes A, B, C, D, and E as shown in FIG. 2. The electrical circuit 200 includes a circuit board 202 configured to electrically connect portions and components of the electrical circuit 200. The circuit board 202 may be any known board including any number of conducting layers separated by insulating layers. As shown in FIG. 2, connecting nodes on the circuit board 202 are indicated by a same character or number. Node 1 is connected to node A; node 2 is connected to node E; node 3 is connected to node B; node 4 is connected to node C; and node 5 is connected to node D.

The second electrical circuit 200 includes a number of electrical components that may be adapted for a particular application of the generator system 100. The second electrical circuit 200 includes terminal outputs 204 and a clock 206. An ON operating state of AC power is indicated by a first lighting device 208, preferably a light emitting diode. An operating state of DC power may be controlled using a switch 212, whereby an ON operating state is indicated by a second lighting device 210. A relay 262 is connected to a photoelectric switch 263 configured to power an electrical device when activated. A step-down circuit 254 configured to produce direct current at a predetermined voltage. A cooling fan 256 is preferably included to reduce thermal energy within the generator system 100 and powered by the step-down circuit 254. Additional electrical components are included as shown in FIG. 2 and function as understood by one skilled in the art from a careful reading of this disclosure.

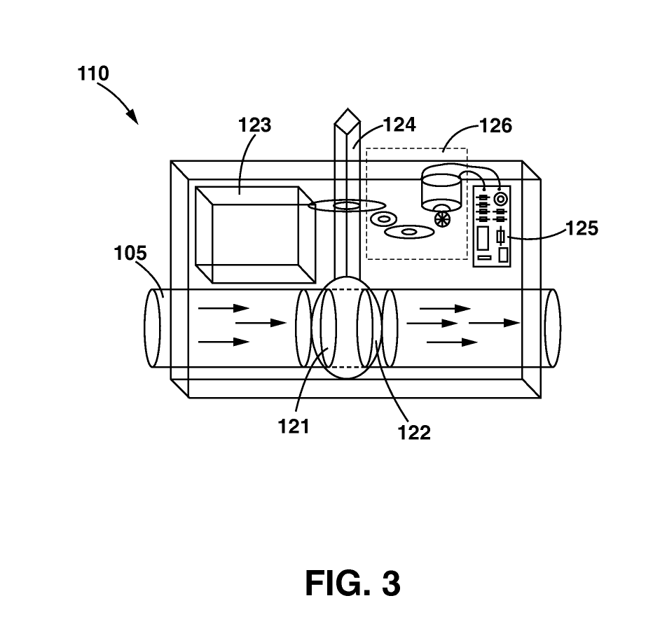

FIG. 3 shows the liquid regulator 110. As FIG. 3 shows, the liquid regulator 110 is configured to control a magnitude of liquid flow routed around the electrical generator 130 utilizing a bypass tube 105 by controlling a magnitude of an opening 121 into the bypass tube 105. The liquid regulator 110 is preferably controlled using the voltage control unit 120 as shown in FIG. 1. Flow rates into the electrical generator 130 affect voltage levels of the electrical energy produced. For example, routing liquid around the electrical generator 130 decreases flow rate into the electric generator. Therefore, by controlling a magnitude of the flow rate into the bypass tube 105 a voltage level produced by the electrical generator 130 may be changed be attenuated or enhanced. The voltage control unit 120 is configured to control the magnitude of the flow rate into the bypass tube 105 by controlling a magnitude of the opening 121 within the liquid regulator 110. The liquid regulator 110 may include a ball valve 122 powered using an electrical energy storage device such as a battery 123. In one embodiment, a manual bypass adjustment means 124 is included to adjust the ball valve 122. A circuit board 125 is preferably communicatively connected to the voltage control unit 120 and configured to control a gear box 126 configured to selectively move the ball valve 122.

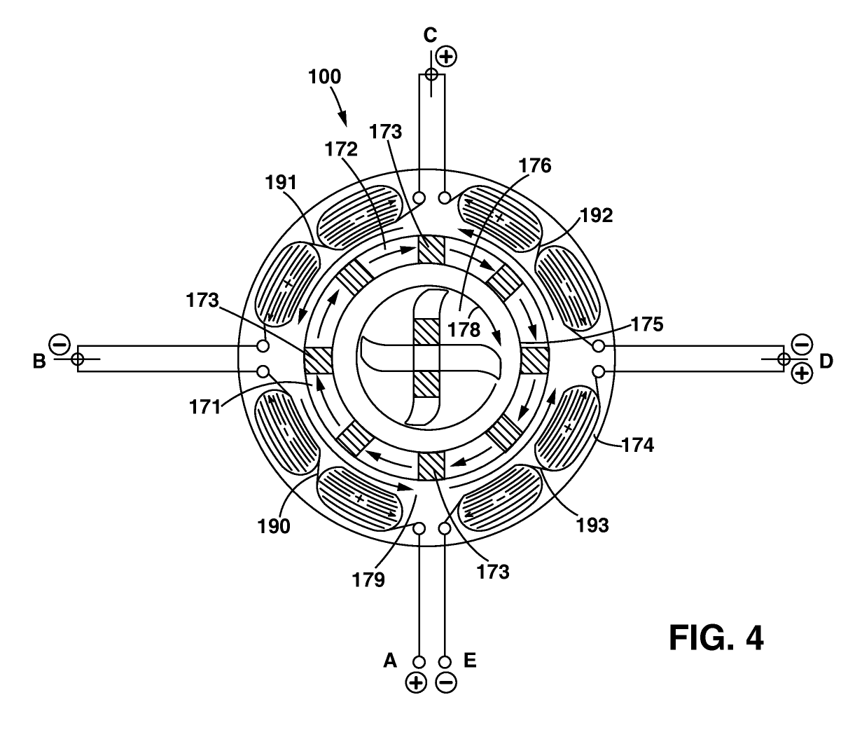

FIG. 4 shows a cross-sectional view of the electric generator system 100 from a perspective of substantially perpendicular liquid flow into the system. As FIG. 4 shows, the electric generator system 100 includes an impeller 170, electromagnetic induction armature 172 and stator 174. The stator 174 includes a first, second, third, and fourth set of coils 190, 191, 192, and 193. As one skilled in the art will recognize from a reading of this disclosure, the number and arrangement of sets of coils can differ in alternate embodiments including embodiments wherein the electrical circuit 150 includes additional components and functionality. In physically larger applications of the present disclosure, multiple additional sets of coils and/or multiple additional sets of coils serially connected to one of the first, second, third, and fourth set of coils 190, 191, 192, and 193 may be included.

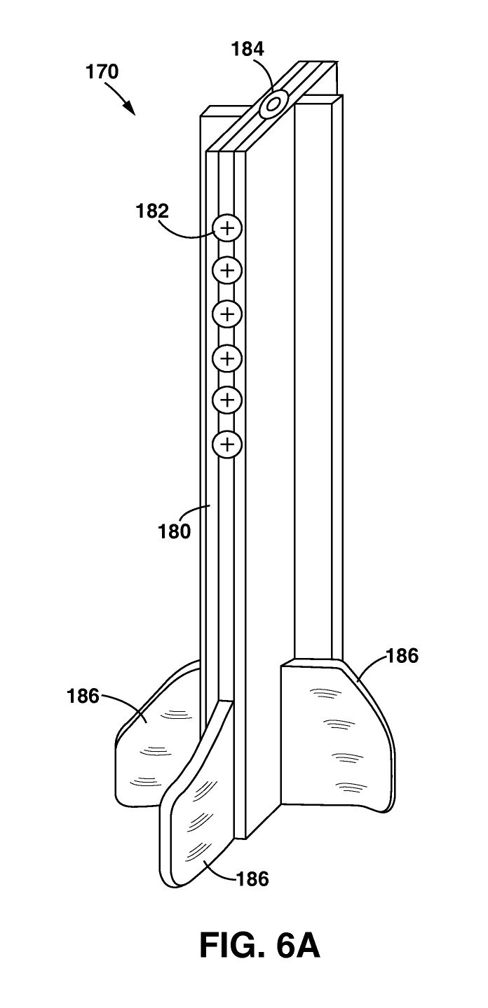

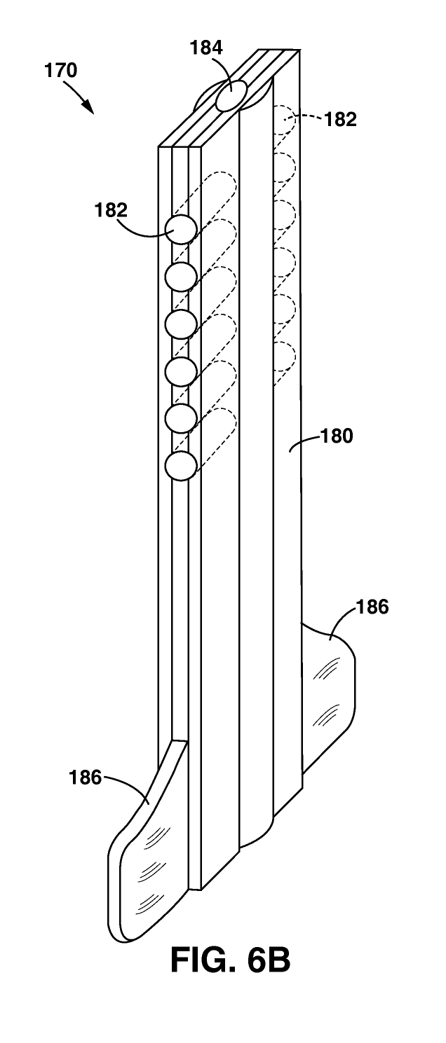

The impeller 170 and the electromagnetic induction armature 172 functions as a rotor in the electrical generator 130. The impeller 170 includes a plurality of magnets as described herein below and shown in exemplary embodiment in FIGS. 6A and 6B. The electromagnetic induction armature 172 includes a plurality of magnets 173, and is moveably connected to the stator 174, preferably using a ring of ball bearings or similar connection means. The impeller 170 is moveably connected to the electromagnetic induction armature 172 using sealed bearings and is configured to moveably rotate in a first direction 178 when propelled by motion of liquid within a cavity 176. The sealed bearings may be any known type including ceramic or porcelain sealed bearings.

The electromagnetic induction armature 172 is configured to generate a magnetic flux in a direction 179 when rotated in a direction 171 adjacent to the stator 174. In operation, motion of the magnets within the impeller 170 generate a magnetic force that attracts the magnets 173 within the electromagnetic induction armature 172 compelling motion of the electromagnetic induction armature 172 in a same direction as the impeller 170. For example, as shown in FIG. 4, clockwise motion 178 of the impeller 170 compels clockwise motion 171 of the electromagnetic induction armature 172 generating a magnetic flux in an opposite, counterclockwise motion 179. The generated magnetic flux induces an electrical current within the coils 190, 191, 192, and 193. Strength of the electrical current generated is based upon, in part, liquid flow rate, magnetic strength, and the number of turns of the coil.

The electromagnetic induction armature 172 is additionally configured to minimize impediment of liquid flow within the electrical generator 130. Walls 175 of the electromagnetic induction armature 172 are preferably adapted to a piping system to enable continuous liquid flow without substantial turbulence from the walls 175 and out from the output tube 103 to a coupled pipe or tube.

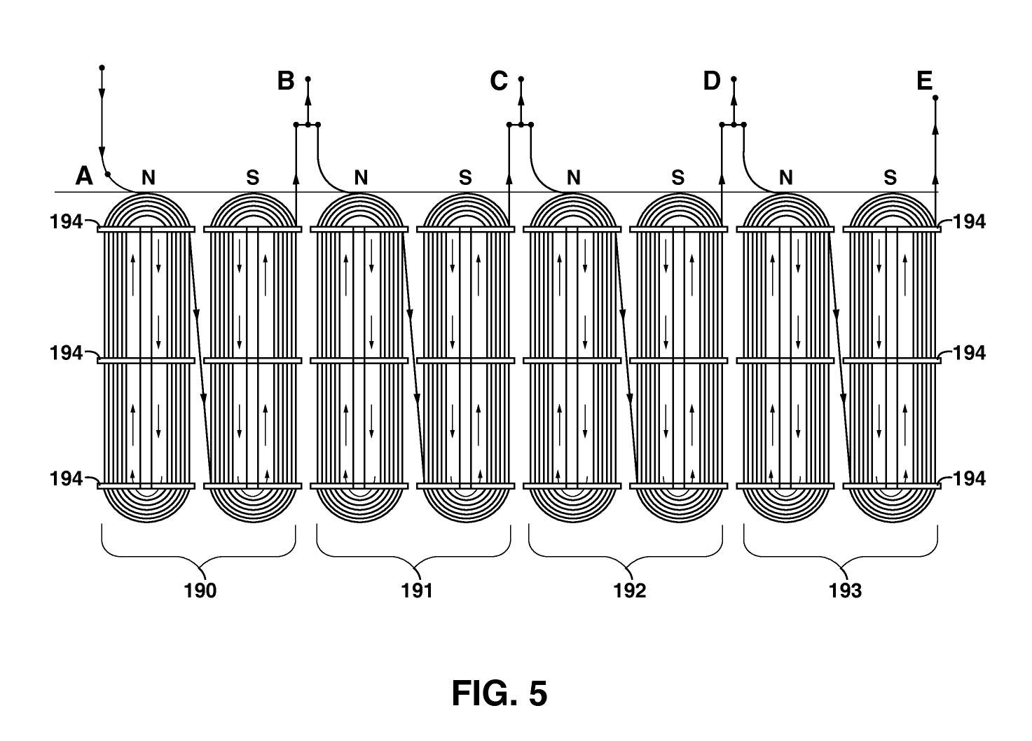

FIG. 5 schematically shows the first, second, third, and fourth set of coils 190, 191, 192, and 193 used to generate electricity in the electrical generator 130. The coils used in the electrical generator 130 may be any known type and gauge adapted for use in a particular application. For example, physically larger embodiments of the present disclosure may more efficiently utilize smaller gauge coil. In one embodiment, the coils are 18 gauge wire and preferably insulated. In one embodiment, the wire is insulated with an enamel coating. The coils function, as one skilled in the art will recognize, to generate electrical current when a magnetic flux is applied to the coils 190, 191, 192, and 193.

As FIG. 5 shows, the first set of coils 190 is connected between node A and node B on the electrical circuit 150. The second set of coils 191 is connected between node B and node C on the electrical circuit 150. The third set of coils 192 is connected between node C and node D on the electrical circuit 150. The fourth set of coils 193 is connected between node D and node E on the electrical circuit 150. The coils 190, 191, 192, and 193 are wound in a figure-eight arrangement, with an electromagnetic north (“N”) and south (“S”) polar region. The coils may be wound into multiple additional shape embodiments including, for example, circular, oval, octagon rectangle, triangle, and square shapes. Multiple coil support members 194 may be included to secure the coils 190, 191, 192, and 193 to the stator 174. The coil support members 194 may be constructed from any known nonconductive material such as plastic, fiberglass, and/or carbon fiber plastic. As described herein above, size, length, and gauge of the coils 190, 191, 192, and 193 may be adapted to a particular application of the electrical generator 130.

FIGS. 6A and 6B show exemplary embodiments of the impeller 170. FIG. 6A shows a four-blade embodiment of the impeller 170, while FIG. 6B shows a two-blade embodiment of the impeller 170. As FIGS. 6A and 6B show, the impeller 170 includes an elongated shaft 180 and a plurality of blades 186. The blades 186 are each configured to generate rotational force from motion of the liquid flow through the electrical generator 130. As one skilled in the art will readily recognize, the number of blades may vary based upon the particular application of the generator system 100 and is therefore not intended to be limited thereby. The shaft 180 includes a plurality of magnets 182 preferably configured on each side of the shaft 180, i.e., approximately 180-degree difference distance. The shaft 180 further includes an axel apparatus 184 configured to permit free rotation of the impeller 170 during operation preferably concentrically aligned with the stator 174. The magnets 182 may be of any known magnetized material including neodymium magnets. In one embodiment, the magnets are rated between N40 to N52. The impeller 170 may be constructed using one of multiple materials including plastic-fiberglass, plastics, polyethylene, embodiments of carbonic plastic non-magnetic metals, and aluminum.

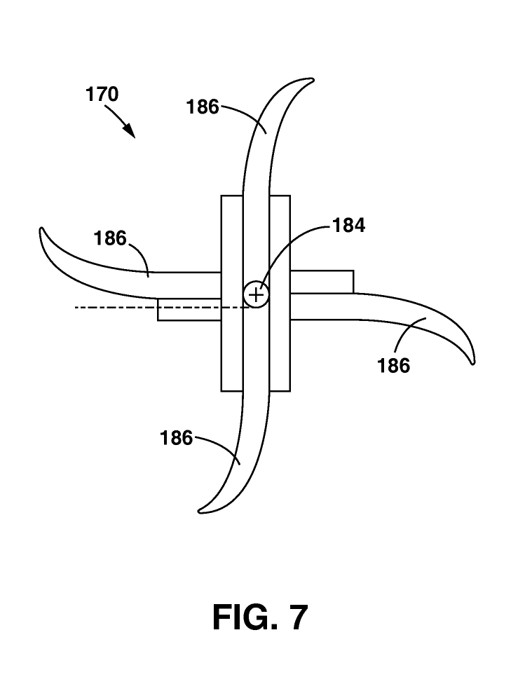

FIG. 7 shows a top view of the impeller 170 shown in FIG. 6A. As FIG. 7 shows, the exemplary impeller 170 includes four blades 186; each blade 186 is of a substantially same shape and size. Alternative embodiments of the impeller 170 may include any number of blades including embodiments having three or more blades, wherein a blade size and shape may be adapted for the particular application and may vary among the blades.

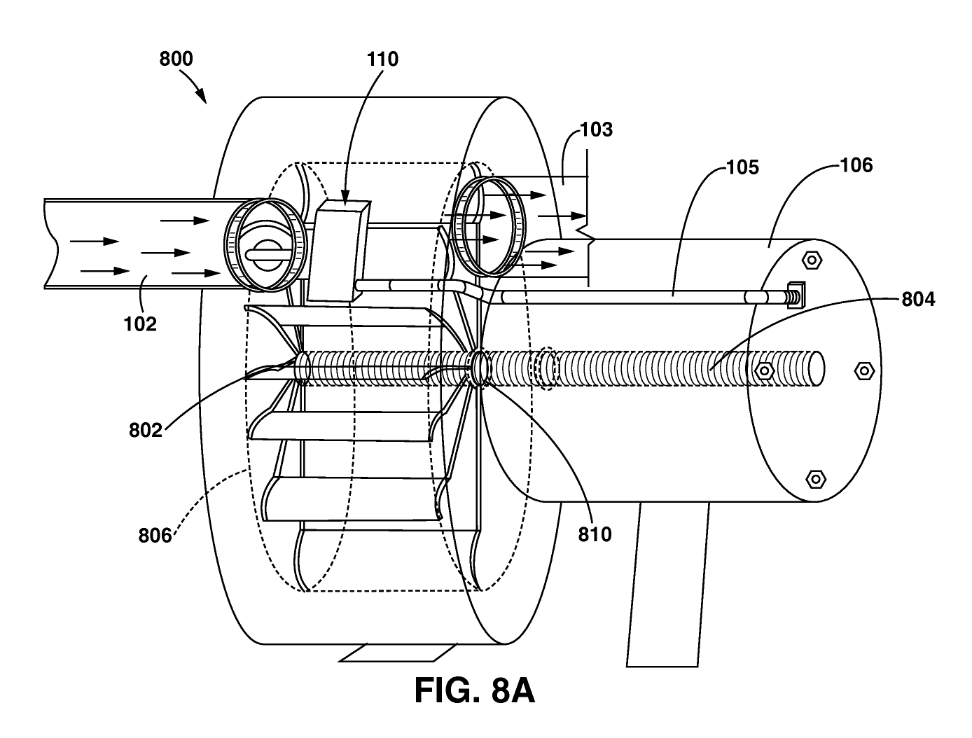

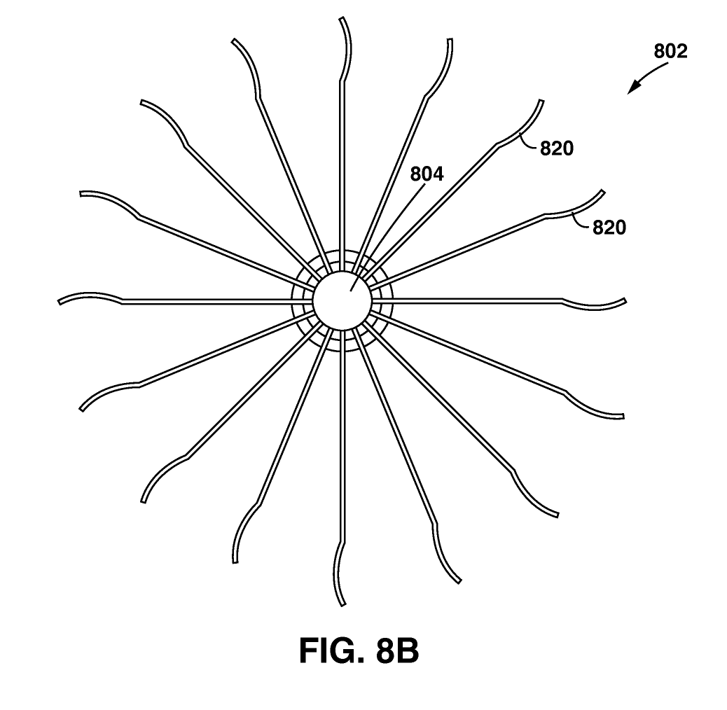

FIG. 8A shows an alternative electric generator system embodiment 800 of an electric generator system 100 using an elliptical impeller 802 that is shown in FIG. 8B. As FIG. 8A shows, the elliptical impeller 802 is rotably attached to an axel 804 enabling the elliptical impeller to rotate freely within a sealed chamber 806. In one embodiment, the elliptical impeller 802 is attached to the axel 804 using sealed ball bearings 810. The axel 804 is mechanically connected to an electric generator configured to generate electrical energy using rotational movement of the axel 804. Liquid flow from the input tube 102 to the output tube 103 generates rotational force rotating the elliptical impeller 802 and the axel 804. In one embodiment, the input tube 102 is connected to the sealed chamber 806 using a butterfly valve.

FIG. 8B shows the elliptical impeller 802, an alternative embodiment of the impeller 170. The elliptical impeller 802 is configured to propel an electrical generator, such as the electrical generator 130 described herein above, using motion of liquid flow through the sealed chamber 806. The elliptical impeller 802 includes a plurality of blades 820. The blades 820 are each configured to generate rotational force from motion of the liquid flow. As one skilled in the art will readily recognize, the number of blades may vary based upon the particular application of the generator system 800 and is therefore not intended to be limited thereby. The blades rotate in a circular manner around the axel 804.

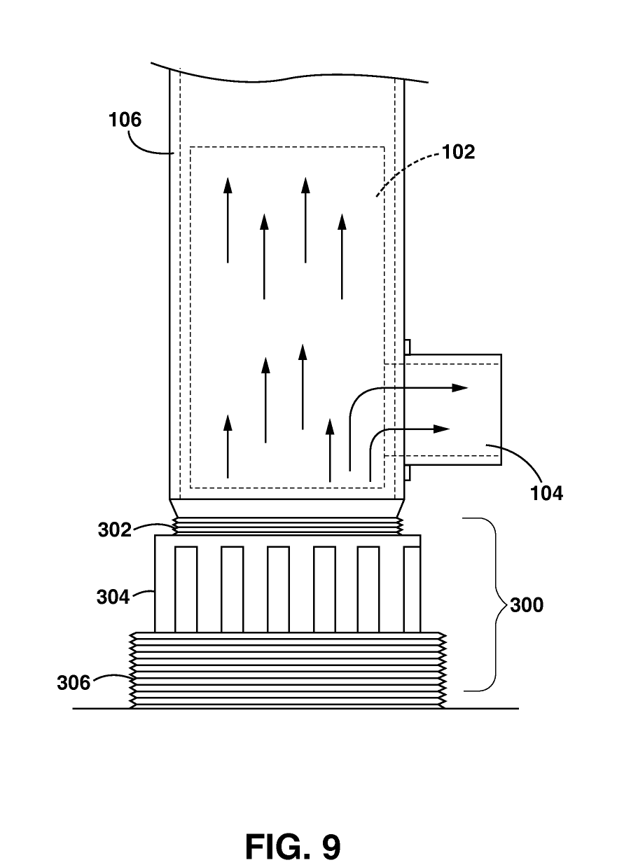

FIG. 9 is a partial sectional side view of the input tube 102 and coupling means 300 for an exemplary application of the generator system 100. The exemplary application includes coupling the generator system 100 to ends of a tube or piping apparatus such as a PVC pipe thereby permitting liquid to flow through the generator system 100. The coupling means 300 can include seals, spacers, and rubber gaskets all configured to prevent liquid leaks and smooth, unencumbered flow of liquid. As one skilled in the art will readily recognize, the output tube 103 may be similarly coupled.

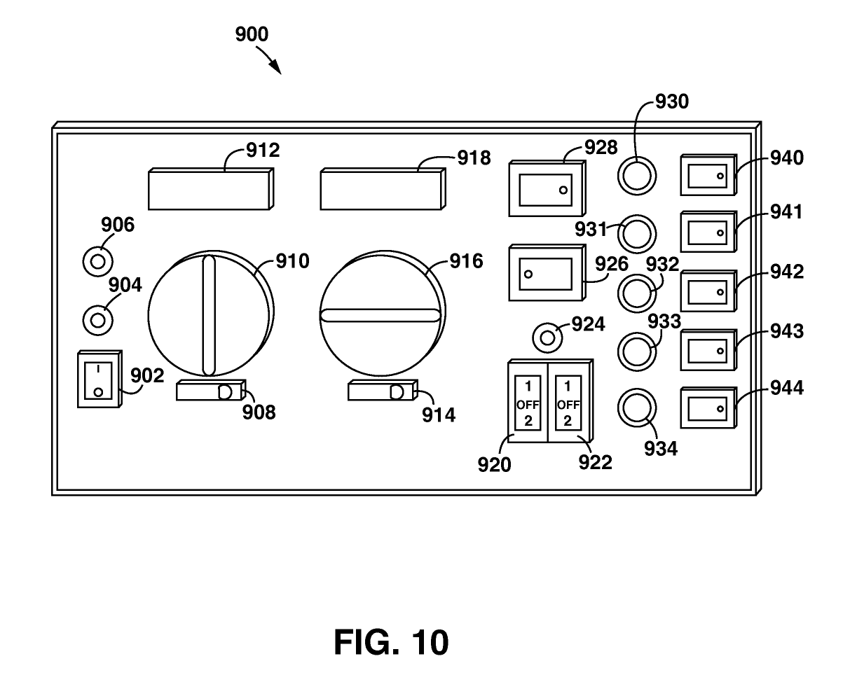

FIG. 10 illustrates an exemplary user interface 900 for controlling operation of the generator system 100. The user interface 900 can include one or more controls, such as buttons, switches, and dials configured to control operation of the generator system 100. For example, in one embodiment, the user interface 900 utilizes a touch screen and digital controls to control operation of the generator system 100. As FIG. 10 shows, the exemplary user interface 900 includes a plurality of switches, dials, and lights for transmitting operational information to a user such as an operating state of a particular component or functionality. A first switch 902 is configured to control a source of direct current power from the electrical generator 130. A first lighting device 904 is configured to indicate an ON operating state of the direct current power source. A second lighting device 906 is configured to indicate an OFF operating state of the direct current power source. In one embodiment, the first lighting device 904 emits a green light when activated. In one embodiment, the second lighting device 906 emits a red light when activated.

A second switch 908 controls an operating state of a first multimeter device. A dial 910 controls a monitoring state of the first multimeter device including orders of magnitude for AC magnitude measurements and DC magnitude measurements. A first display device 912 displays monitored readings of the first multimeter device. A third switch 914 controls an operating state of a second multimeter device. A dial 916 controls a monitoring state of the second multimeter device including orders of magnitude for AC magnitude measurements. A second display device 918 displays monitored readings of the second multimeter device.

Third and fourth switches 920 and 922 are preferably configured to control power sources outputs to AC and DC operating states. A lighting device 924 is configured to indicate whether an AC power source is at an ON operating state. Switches 926 and 928 are configured to switch monitoring of coils within the electrical generator 130 when actuated. In one embodiment, switch 926 is configured to change monitoring from a ‘B-C’ node electrical power reading to a ‘C-D’ node electrical power reading, and switch 928 is configured to change monitoring from a ‘C-D’ node electrical power reading to a ‘B-D’ node electrical power reading using one of the multimeter devices.

The user interface 900 additionally includes access to the fuses 930, 931, 932, 933, and 934 which may be configured with lighting functionality, wherein a fuse emitting a light indicates a functioning fuse. Switches 940, 941, 942, 943, and 944 control connections to coils within the electrical generator 130. As shown in FIG. 1, switch 940 controls connection to node B. Switch 941 controls connection to node A. Switch 942 controls connection to node E. Switch 943 controls connection to node C. Switch 944 controls connection to node D.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An electrical generator apparatus for generating electrical energy utilizing liquid flow within a tubular member, the apparatus comprising:
a rotor comprising an impeller moveably connected to an electromagnetic induction armature, wherein the rotor is configured to receive liquid flow within the electromagnetic induction armature from the tubular member, and wherein the impeller includes a plurality of blades, each blade submerged within liquid when receiving liquid flow;
a stator configured to generate electrical energy within a plurality of coils utilizing a magnetic flux generated by the electromagnetic induction armature when rotated adjacent to the stator; and
a bypass tubular member configured to selectively route liquid around the electrical generator.

2. The apparatus of claim 1, wherein the bypass tube includes a liquid regulator configured to control a magnitude of liquid flow around the electrical generator.

3. The apparatus of claim 2, further comprising:
a voltage control unit configured to control the liquid regulator to adjust voltage of generated electrical energy.

4. The apparatus of claim 1, further comprising:
an electrical circuit electrically connected to the plurality of coils, the electrical circuit configured to modulate generated electrical energy.

5. The apparatus of claim 4, wherein the electrical circuit includes circuitry for operating an electrical outlet using alternating current.

6. The apparatus of claim 4, wherein the electrical circuit includes circuitry for proving a direct current power source.

7. The apparatus of claim 1, wherein the impeller comprises magnets configured to magnetically attract magnets within the electromagnetic induction armature.

8. The apparatus of claim 7, wherein the impeller comprises a plurality of blades configured to generate rotational force from motion of the liquid flow through rotor, rotating the impeller and magnetically attracting the electromagnetic induction armature to rotate in a similar rotational motion.

9. The apparatus of claim 1, wherein the impeller comprises an elongated shaft that includes magnets on a first end and blades on a second end.

10. The apparatus of claim 1, wherein the impeller is elliptical.

11. The apparatus of claim 1, wherein the electromagnetic induction armature is moveably connected to the stator using ball bearings.

12. An electrical generator apparatus for generating electrical energy utilizing liquid flow within a tubular member, the apparatus comprising:
a rotor comprising a circular impeller mechanically connected to an electromagnetic induction armature, wherein the rotor is configured to receive liquid flow within the electromagnetic induction armature from the tubular member, and wherein the impeller is entirely submerged within liquid when receiving liquid flow;
a stator moveably connected to the electromagnetic induction armature and configured to generate electrical energy within a plurality of coils utilizing a magnetic flux generated by the electromagnetic induction armature when rotated adjacent to the stator; and
a bypass tubular member configured to selectively route liquid around the electrical generator.

13. The apparatus of claim 12, wherein the tubular member is less than 4 inches in diameter.

14. The apparatus of claim 12, wherein the impeller is entirely submerged within liquid during operation.

15. The apparatus of claim 12, wherein the electromagnetic induction armature includes a plurality of neodymium magnets.

16. Method for generating electrical energy, the method comprising:
coupling an electrical generator apparatus to a tubular member configured to supply liquid to the electrical generator apparatus, the electrical generator comprising:
a rotor comprising an impeller moveably connected to an electromagnetic induction armature, wherein the rotor is configured to receive liquid flow from the tubular member within the electromagnetic induction armature,
a stator configured to generate electrical energy within a plurality of coils utilizing a magnetic flux generated by the electromagnetic induction armature when rotated adjacent to the stator, and
a bypass tubular member configured to route liquid around the electrical generator;
receiving liquid flow from the tubular member into the rotor;
utilizing the liquid flow to rotate the rotor;
generating a magnetic flux within the stator; and
generating electrical energy from the magnetic flux within the plurality of coils.

17. The method of claim 16, further comprising:
adjusting an opening of a liquid regulator configured to control a magnitude of liquid flow around the electrical generator utilizing the bypass tubular member to control voltage of the generated electrical energy.

18. The method of claim 16, wherein the tubular member is part of a water supply system configured to flow water through the tubular member.

19. The method of claim 16, further comprising:
powering an electrical device using the generated electrical energy.
